(19) United States
(12) Patent Application Publication
(10) Pub. No.: US 2012/0246036 A1
(43) Pub. Date: Sep. 27, 2012

(54) SYSTEM, METHOD AND COMPUTER READABLE MEDIUM FOR CONDUCTING A VEHICLE AUCTION, AUTOMATIC VEHICLE CONDITION ASSESSMENT AND AUTOMATIC VEHICLE ACQUISITION ATTRACTIVENESS DETERMINATION

(75) Inventors: Thomas W. Marr, Purcellville, VA (US); Anton Chakirov, Leesburg, VA (US); Dmitry Gorodchanin, Leesburg, VA (US)

(73) Assignee: Autonig, LLC

(21) Appl. No.: 13/426,934

(22) Filed: Mar. 22, 2012

Related U.S. Application Data
(60) Provisional application No. 61/466,305, filed on Mar. 22, 2011.

(51) Int. Cl. G06Q 30/06

(52) U.S. Cl. 705/27.1

(57) ABSTRACT

Systems, methods and computer readable media for a computerized vehicle auction, vehicle condition assessment and vehicle acquisition attractiveness assessment.

### CROSS-REFERENCE TO RELATED APPLICATIONS

The present application claims the benefit of U.S. Provisional Application No. 61/466,305, filed Mar. 22, 2011, which is incorporated herein by reference in its entirety.

### FIELD

Embodiments relate generally to vehicle auctions and, more particularly, to systems, methods and computer readable media for a computerized vehicle auction, vehicle condition assessment and vehicle acquisition attractiveness assessment.

### BRIEF DESCRIPTION OF THE DRAWINGS

FIG. 1 is a diagram of an exemplary system in accordance with the present disclosure.

FIG. 2 is a chart showing a method for listing and selling a vehicle in accordance with the present disclosure.

FIG. 3 is a chart showing a method in facilitating a vehicle auction in a server computer in accordance with the present disclosure.

FIG. 4 is a chart showing a method for receiving and bidding on vehicles up for auction in accordance with the present disclosure.

FIG. 5 is a diagram of an exemplary seller device with optional peripherals in accordance with the present disclosure.

FIG. 6 is a diagram of an exemplary server computer or seller device showing information flow n accordance with the present disclosure.

FIG. 7 is a chart of a method for automatically assessing vehicle condition in accordance with the present disclosure.

FIG. 8 is a chart of a method for automatically generating a measure of vehicle acquisition attractiveness in accordance with the present disclosure.

### DETAILED DESCRIPTION

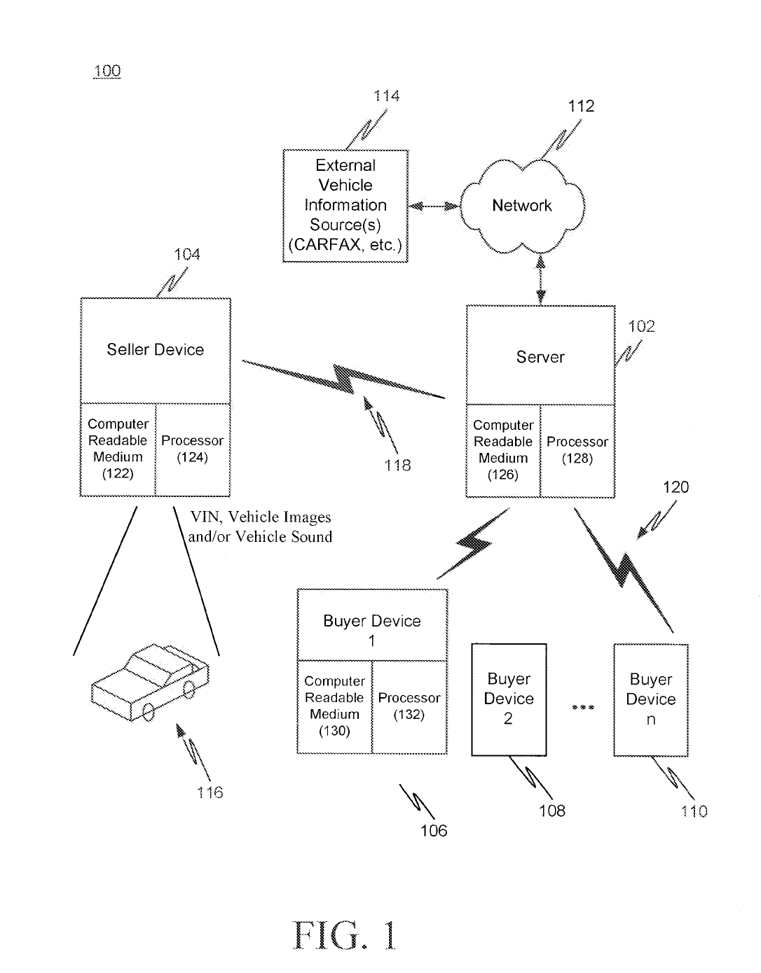

FIG. 1 shows a system 100 having a server computer 102, a seller device 104 and one or more buyer devices (106-110). The server computer 102 can be coupled to a network 112 and to one or more external information sources 114. The seller device 104 can be used to obtain an image or other information from a vehicle 116. The seller device 104 can communicate with the server computer 102 via link 118. The server computer 102 can communicate with the buyer devices (106-110) via link(s) 120.

The seller device 104 includes a nontransitory computer readable medium 122 and a processor 124. The server computer 102 includes a nontransitory computer readable medium 126 and a processor 128. The buyer device 106 includes a nontransitory computer readable medium 130 and a processor 132. Buyer devices 108 and 110 can also include a nontransitory computer readable medium and a processor.

The server computer 102 can include a single server computer, a distributed server computer, a cloud computing system or any computing system suitable for performing server functions. In general, any computing device capable of being programmed to perform server function in accordance with the present disclosure can be used.

The seller device 104 and each of the buyer devices (106-110) can be a wireless phone (e.g., an Apple iPhone, a feature phone, a smart phone or the like), a personal digital assistant (e.g., a Blackberry, a Palm Pilot, a Windows Mobile device or the like), a portable computer (e.g., a laptop, netbook, notepad computer, tablet computer, Apple iPad, palm top computer or the like), an ebook reader (e.g., Amazon Kindle, Barnes and Noble Nook, Sony ebook reader or the like), a portable media player (e.g., Apple iTouch or the like), a desktop computer (e.g., a PC-compatible, an Apple Macintosh, or the like) or other suitable computing device. In general, any computing device capable of being programmed to perform the seller device and/or buyer device functions in accordance with the present disclosure and as described herein can be used.

Each nontransitory computer readable medium mentioned above (122, 126 and 130) can include RAM, ROM, EEPROM, flash memory, CD, DVD, magnetic disc drive, optical disc drive, electronic memory and/or any now known or later developed computer readable medium suitable for storing instructions and/or data.

Each processor (124, 128 and 132) can include a microprocessor, microcontroller, digital signal processor, application specific integrated circuit, programmable logic device and/or the like.

The network 112, link 118 and link(s) 120 can each include one or more of a local area network, a wide area network, the Internet, a virtual private network, a wireless network (WiFi, cellular, Bluetooth or the like), a wired network or the like.

In operation, a seller (e.g., an individual vehicle owner or a dealer) can use the seller device 104 to create an auction listing for the vehicle 116. The software for the auction listing process can be executed from the seller device 104 nontransitory computer readable medium 122. The software can be, for example, an application (or “app”) that is downloaded from an online application marketplace such as that provided for the iPhone, Android, Blackberry and Palm wireless devices. Alternatively, or in addition to an application, the software can be provided from the server computer 102 in the form of software as a service or as a web service. The seller can use the seller device 104 to obtain an image of the vehicle identification number (VIN) for the vehicle 116. Alternatively, the seller can input the VIN directly into the seller device 104 via typing or vice, or by other identification method such as RFID, barcode or the like. In place of, or in addition to, the VIN, relevant vehicle identification number (e.g., stock number) or description year, make, model, body and/or trim) can be used.

In another alternative, the vehicle information may also exist in a database. For example, dealers wishing to sell vehicles to other dealers will typically have the relevant vehicle information in an existing inventory system (e.g., ecarlist, autorevo, DealerTrack, FirstLook, Reynolds & Reynolds, vAuto, and the like). When a dealer wishes to sell a vehicle, the dealer can “load” the relevant information from a database and “push” the listing to potential buyers via the system 100.

Once the VIN (or other vehicle identification information, such as make, model, body style and/or trim package) has been obtained at the seller device 104, the seller device 104 communicates the VIN to the server computer 102 via the link 118. The server computer 102 can decode the VIN and determine the make, model and year of the vehicle based on the VIN. The server computer 102 can then retrieve a list of specific option questions tailored to the determined make, model and year of the vehicle and transmit those questions to the seller device 104. The questions can be sent to the seller device 104 in part or in whole. For example, the server computer 102 can provide the make, model and year-specific questions to the seller device 114 one at a time and receive an answer before proceeding to the next question. Or, the server computer 102 can provide the make, model and year specific questions to the seller device 104 all at once and await a response including answers to each question.

In addition to providing answers to the make, model and year specific option questions, the seller can provide condition information (e.g., in the form of a standardized condition report having a fixed, predetermined format as opposed to free-form listings such as those commonly found in online auction and classified services). The condition information can be obtained by the seller device 104 as part of the auction listing process in which software in the seller device 104 steps the seller through a series of condition related questions in order to complete the standardized condition report, for example.

In addition to the options and condition information, the seller can provide still images or video images. The seller device 104 can include a built-in imaging device or can be coupled to an external peripheral imaging device. Using the imaging device, the seller device 104 can obtain one or more images (or videos) of the vehicle 116. The images or videos can be transmitted to the server computer 102 via the link 118. In addition to condition, the location of the vehicle 116 can be provided. The location can be automatically determined (e.g., using a location device such as GPS located within the seller device 104, cellular triangulation, IP address, or the like) or manually input through a user interface.

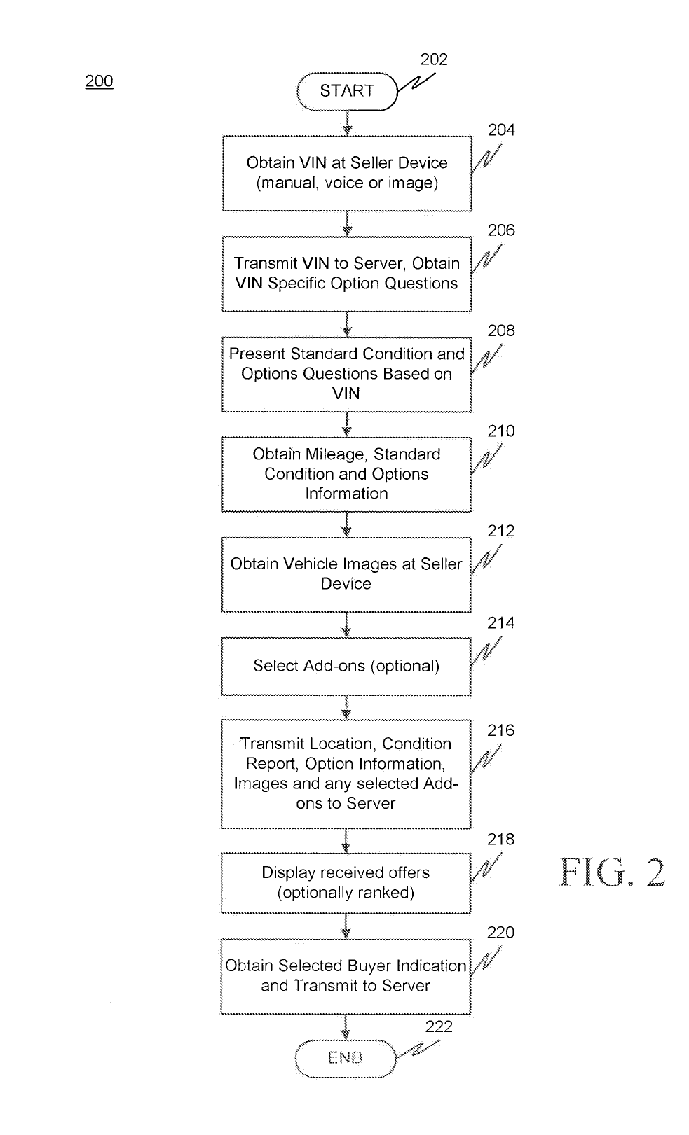

Other information, such as text or audio narrative about the vehicle, can be inputted to the seller device 104 using an appropriate input device (e.g. keypad, touch screen or microphone) via a user interface. The other information can be transmitted from the seller device 104 to the server computer 102 via the link 118. The seller can also select optional services, which are discussed in greater detail below in the description of 214 in FIG. 2.

Once the vehicle listing information (e.g., condition, options, images, geographic location of the vehicle and other information) has been sent to the server computer 102, the server computer 102 can create a new offer listing and store the new listing information in a database coupled to the server computer 102. The server computer 102 can then push the new listing to one or more buyer devices (106-110) each corresponding to a prospective buyer (e.g., a vehicle dealer). The buyers to which the new listing is sent can be selected from the group of all buyers registered in server computer 102 according to one or more criteria such as geographic location of the buyer, predicted interest of the buyer, indicated preferences of the buyer, reputation of the buyer, or according to any other suitable criteria.

The buyer devices (106-110) can be programmed to display the new listing in real-time or in non-real time. The bids can be displayed on a display device coupled to, or integrated with, each corresponding buyer device. As the listings are displayed on the buyer devices (106-110) and reviewed by each corresponding buyer, any buyer can place a bid or make an offer for the vehicle 116. The bids can be conditioned on an inspection of the vehicle 116. Each bid is sent by the corresponding buyer device to the server computer 102 and can include information such as buyer identification, bid amount, etc. The server computer 102, in turn, can be programmed to record each bid and forwards the bids to the corresponding seller device 104. The server computer 102 can be programmed to add additional information to the bids transmitted to each seller. For example, the server computer 102 can be programmed to add buyer reputation (e.g., based on successful transactions), rating (e.g., based on seller feedback regarding buyer) and/or location information. The bids received by the seller device 104 can be displayed on a display device coupled to, or integrated with, the seller device 104.

The server computer 102 can be programmed to determine an initial group of buyer devices to push the vehicle listing to. For example, the group of all buyers in the system can be filtered according to one or more criteria based on likelihood of interest (e.g., location, buying patterns, sales patterns, VIN scanning patterns, wish lists, local market factors, or the like). The vehicle listing can be pushed to a buyer's mobile phone based on predicted interest in the vehicle (e.g., due to wish list, buying history, scanning history, sales history, regional demand factors, or the like). If the number of bids is less than a predetermined threshold after a certain period of time, the server computer 102 can be programmed to push the vehicle listing to a next group of buyer devices. The server computer 102 can be programmed to continue in this manner to expand the number buyer devices the listing is pushed to in an attempt to generate the predetermined number of bids.

The server computer 102 can also be programmed to transmit the listing to another online service, such as an online auction (e.g., eBay), online classifieds site (e.g., Craigslist), or other online marketplace or ad listing service, after a predetermined amount of time has elapsed since the new listing was first created, and/or when a predetermined number of bids for the vehicle have been received.

The seller can review the received bids including the amount, the buyer identification, buyer reputation or ranking and buyer location. The identity of the seller can remain anonymous until the conclusion of the auction, or the seller can choose to disclose his or identity before or during the auction. Using a user interface displayed on the seller device 104, the seller can select a bidder as the “winning” bidder based on bid price and/or any other criteria such as seller rating of buyer, buyer reputation, Better Business Bureau (BBB) rating, ChoicePoint rating, or the like. Also, the seller may not have to explicitly select a winning bid/offer, as the system can carry out the sale as an auction (interested parties bid on the vehicle rather than respond to a fixed price offer) and/or a classified ad (seller determines who wins). Using a user interface displayed on the seller device 104, the seller can set a time for the auction to end or can choose to end the auction at any time.

Once the seller selects a winning bidder, the seller device 104 can transmit contact information for the seller, including one or more of seller name, contact telephone number for seller, email address for seller, vehicle location address and picture of seller, to the server computer 102. The server computer 102 can, in turn, transmit the seller information to the buyer device corresponding to the winning buyer.

FIG. 2 shows a method 200 for computerized listing and selling of a vehicle. Processing begins at 202 and continues to 204.

At 204, a vehicle identification number (VIN) is obtained at a seller device. The VIN can be obtained automatically by decoding an image of the VIN plate on a vehicle captured by an imaging device in the user device, or can be manually entered via a keypad, touch screen or voice input. Processing continues to 206.

At 206, the VIN is transmitted to a server computer and one or more make, model and year specific option questions are obtained, as described above regarding operation of the server computer 102 of FIG. 1. Processing continues to 208.

At 208, a set of standardized condition questions and the make, model and year-specific vehicle option questions are presented to the seller. Processing continues to 210.

At 210, answers to the condition and option questions and the vehicle mileage are obtained at the seller device. Also, a location of the vehicle can be obtained. The location can be automatically determined (e.g., using a built-in GPS of a wireless phone) or manually input using a keypad, touch screen or voice input. Processing continues to 212.

At 212 one or more still or video images are obtained of the vehicle. These images can be captured by an imaging device in the seller device (e.g., via a built-in camera in an iPhone) or transferred from a memory device (e.g., flash memory card) or another system. The images can be obtained with guidance from software in the server or seller device. For example, the server or seller device can prompt the seller to take images according to standard poses or vehicle orientations by using wire-frames to guide the framing of the image in the imaging device. Processing continues to 214.

At 214, one or more add-ons are optionally presented to the seller on the seller device. The seller can select any of these optional add-on services in conjunction with the auction listing. The add-on services can include, but are not limited to, insurance, warranty, certified inspection, escrow, third party vehicle exchange, pricing guides, AutoCheck, CARFAX, recent sales prices, and/or the like. Processing continues to 216.

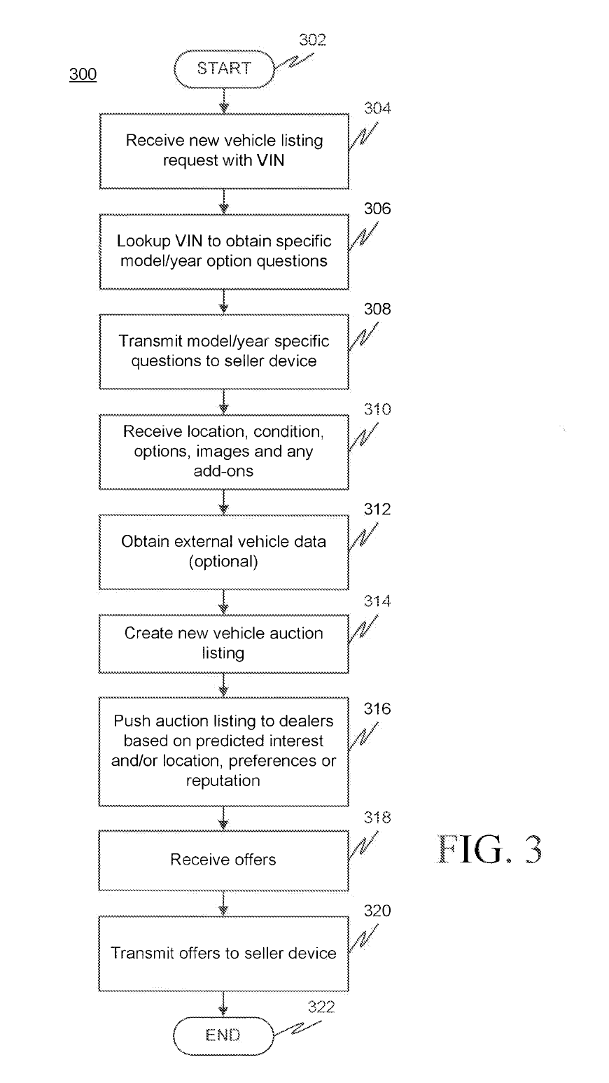

At 216, the vehicle location, condition, images, options and any selected add-on services are transmitted to the server. The server processes the new listing information as described below in connection with FIG. 3. Processing continues to 218.

At 218, any offers or bids received from the server are displayed on the seller device. Optionally, the received bids can be stored at the server and accessed by the seller through a web interface so that the seller can view received bids from any computer with Internet access, for example. The offers or bids optionally can be ranked according to buyer (or bidder) reputation and/or ranking. Processing continues to 220.

At 220, an indication of a winning bidder, if any, is obtained at the seller device or through a web-based interface. The winning bidder can be the highest bidder (similar to an auction format) or a bidder selected by the seller used on other criteria (e.g., rating of bidder). The indication of the winning bidder is transmitted to the server, and contact between the seller and winning bidder can be facilitated. Processing continues to 222, where processing ends.

It will be appreciated that 202-222 can be repeated in whole or in part in order to accomplish a contemplated vehicle auction process.

FIG. 3 is a chart showing a method 300 for facilitating a vehicle auction in a server computer in accordance with the present disclosure. In particular, processing begins at 302 and continues to 304.

At 304, the server computer receives a new auction listing request along with a VIN. The request originates with a seller device. Processing continues to 306.

At 306, the VIN is decoded or otherwise processed to determine a make, model and year of the vehicle that is the subject of the new auction listing request. Using the make, model and year (or a portion of the VIN) the server computer queries a database to retrieve make, model and year-specific option questions. Processing continues to 308.

At 308, the server computer transmits the retrieved option questions to the seller device either individually or in one or more groups. Processing continues to 310.

At 310, the server computer receives information about the vehicle including condition, options, location and images. The server computer also receives an indication of any add-on services requested by the seller. Processing continues to 312.

At 312, vehicle information is optionally obtained from an external source different than the seller. Obtaining information from the external source can be initiated by a prospective buyer, by the seller, or can be performed automatically by the server computer according based on a configuration parameter setting. Processing continues to 314.

At 314, the server computer creates a new vehicle auction listing, including the vehicle information provided by the seller and any other externally supplied vehicle information, and stores the new listing in a database. Processing continues to 316.

At 316, the new auction listing is pushed to prospective buyers (e.g., dealers) based on one or more of predicted interest, location, preferences and reputation. The predicted interest can be determined by a computer and can be based on information such as prior vehicle purchases, prior vehicle listings viewed, prior vehicle searches performed, buyer location, prior vehicle sales records. Interest can be predicted using statistical or mathematical techniques such as regression models, time series models, collaborative filtering, bipartite matching, k-nearest neighbors or the like. Alternatively to, or in addition to, predicted interest, geographic location of the buyer, vehicle preferences of the buyer, buyer reputation and/or ranking can be used to select a buyer to push the new vehicle listing to. Processing continues to 318.

At 318, the server computer receives offers or bids, if any, for the newly listed vehicle auction. The bids can include a monetary amount and an identification of the bidder. Processing continues to 320.

At 320, offers received at the server computer are transmitted to the seller device. The transmitted offers can include information such as bid price, bidder identification, bidder reputation and/or rating. If more than one bid was received at the server computer, the bids can be sorted at the server computer or tint the seller device and ranked according to a criterion such as bid price, bidder rating or bidder reputation. Processing, continues to 322, where processing ends.

It will be appreciated that 302-322 can be repeated in whole or in part in order to accomplish a contemplated vehicle auction process.

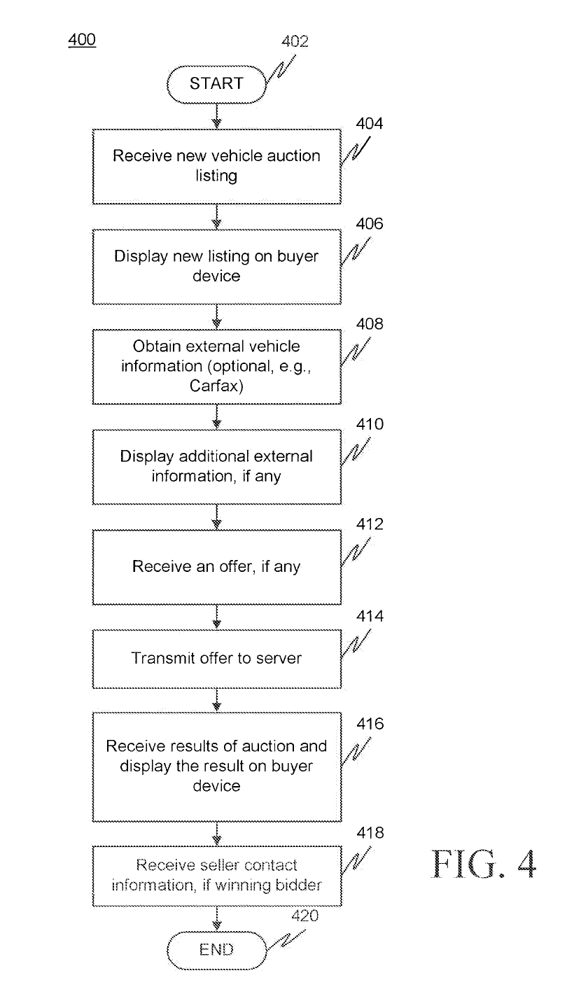

FIG. 4 is a chart showing a method 400 for receiving vehicle auction listings and bidding on vehicles up for auction in accordance with the present disclosure. In particular, processing begins at 402 and continues to 404.

At 404, a newly created vehicle auction listing is received at a buyer device. Processing continues to 406.

At 406, the newly created listing is displayed on the buyer device. The display can be in the form of a user interface showing one or more vehicle auction listings that were pushed to the buyer device. Processing continues to 408.

At 408, vehicle information is optionally obtained from an external information source (e.g., Carfax). The request for external information can be initiated manually by the buyer or automatically by the buyer device according to a configuration parameter setting. The external information can also include a price anchoring service to provide illustrations of recent sales of similar cars, which can be used by the buyer and also provided to the seller to help set reasonable sales price expectations. Processing continues to 410.

At 410, any additional information obtained from the external information source is displayed on the seller device. Processing continues to 412.

At 412, an offer from the buyer is received. The offer can include a bid price and can be conditional based on an inspection of the vehicle and confirmation of the vehicle condition and options. Processing continues to 414.

At 414, the offer is transmitted to the server computer. Processing continues to 416.

At 416, a result of the auction of the newly listed vehicle is displayed. The auction result can be displayed once the auction ends. An interim result can also be displayed. The final result or interim result can show information such as number of bidders, bid values, bidder ranks or reputations, etc. Processing continues to 418.

At 418, if the buyer was selected as the winning bidder, the auction result can also show seller contact information including items such as email to contact seller, phone number to contact seller, seller and/or vehicle address, and/or picture of seller. Processing continues to 420, where processing ends.

It will be appreciated that 402-420 can be repeated in whole or in part in order to accomplish a contemplated vehicle auction process.

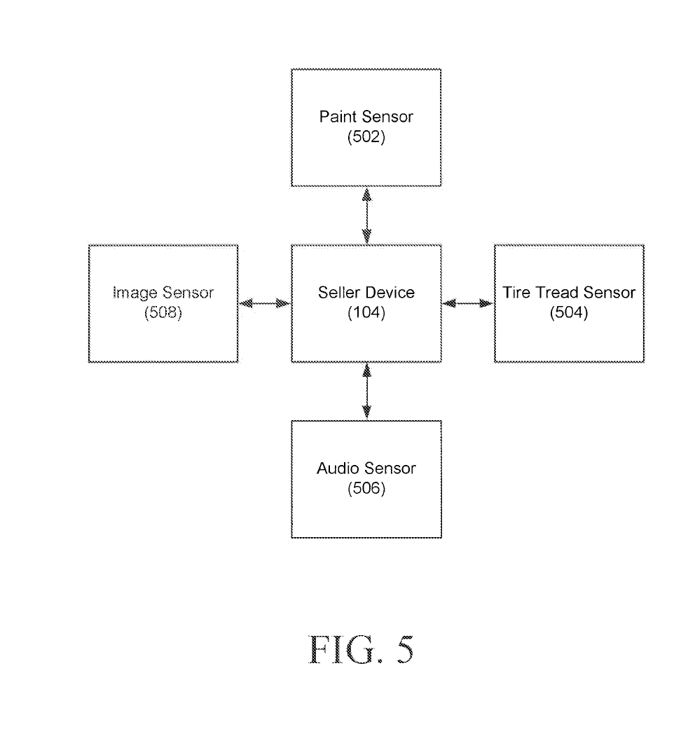

FIG. 5 is a diagram of an exemplary seller device with optional peripherals. In particular the seller device 104 can be coupled or connected with a paint sensor 502, a tire tread sensor 504, an audio sensor 506 and an image sensor 508.

The paint sensor 502 can include a paint thickness meter or sensor such as one manufactured by Nicety, PaintGage, Defelsko, Newest Products and others. The paint sensor 502 can be a stand alone device or can be coupled to or integrated with the seller device. The paint sensor 502 can measure the thickness or quality of the paint on a vehicle. The data from the paint sensor 502 can be transmitted to the seller device 104.

The tire tread sensor 504 can include a mechanical sensor for measuring the depth of tread on the tires of vehicle. Alternatively, the tire tread sensor 504 can be the image sensor 508 coupled to the seller device 104. Using an imaging technique, the image sensor 508 can be used to capture an image of each tire to determine tread depth. The images can be taken with a reference object in the image (e.g., a penny inserted in the groove of the tire tread) or without a reference object in the image.

The audio sensor 506 can be a built-in microphone (e.g., the microphone built into a wireless phone) or an external microphone. The audio sensor 506 can be used to obtain voice recordings. The audio sensor 506 can also be used to obtain engine sounds in order to confirm engine condition.

The image sensor 508 can be the imaging device can be a built-in digital camera such as that commonly found on wireless phones. Alternatively the image sensor can be a separate device for capturing an image and can be coupled to the seller device 104 using a wired or wireless connection.

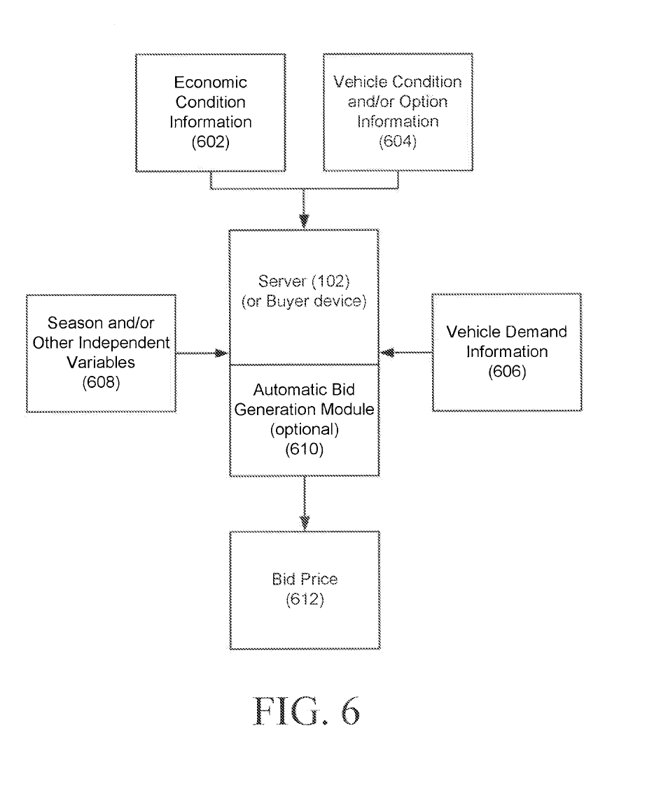

FIG. 6 is a diagram of an exemplary server computer or seller device showing information flow. In particular, the server 102 can receive economic condition information 602, vehicle condition and/or option information 604, vehicle demand information 606, season and/or other independent variables 608. The server 102 can also include an automatic bid generation module 610.

In operation, the server 102 receives economic condition information 602. Economic condition information can include information such as the price of gasoline or diesel fuel, general economic conditions of indicators (e.g., GDP, inflation, unemployment, etc.), vehicle taxes (local, state or federal), vehicle tax credits or tax exemptions (local, state or federal), accounting practices, Internal Revenue Service rules, etc.

The server 102 also receives vehicle condition and option information 604. The vehicle condition information can include an indication of any damage to the exterior of the vehicle, a rating of the interior of the vehicle (e.g., carpet, seats, headliner, door panels and dashboard), rating of Mechanical components (e.g., engine, transmission, air conditioner, brakes, exhaust, power windows/doors/locks, sound equipment, tires, mileage, etc.).

The server 102 can also receive vehicle demand information 606. Vehicle demand information 606 can be determined from historical sales records maintained in the server 102 and/or from external sources, such sales records from external sources.

The server 102 can also receive or determine the season and other independent variables 608. For example, the server 102 can receive a profitability guideline of the buyer and the weight of the vehicle (e.g., for determining cost of shipping). The season can play an important role in vehicle demand. For example, in northern states in the winter, a convertible car may be less in demand (and consequently have a lower value) than during the spring or summer in those same states. Dealer may engage in seasonal arbitrage (time) and/or geographic arbitrage (location).

The server 102 can provide the received or determined information 602-608 to the buyer device. Alternatively, the server can provide the received or determined information 602-608 to the automatic bid generation module 610. The automatic bid generation module 610 can automatically determine a bid for the vehicle based on a standard value of the vehicle based on condition and options with a modification value based on the economic conditions, vehicle demand and season or other independent variables. By taking into account the various items of information shown in FIG. 6, the automatic bid generation module can determine an accurate bid price.

While described in connection with the server 102, it will be appreciated that the information flow and processing described in FIG. 6 can also be performed at a buyer device.

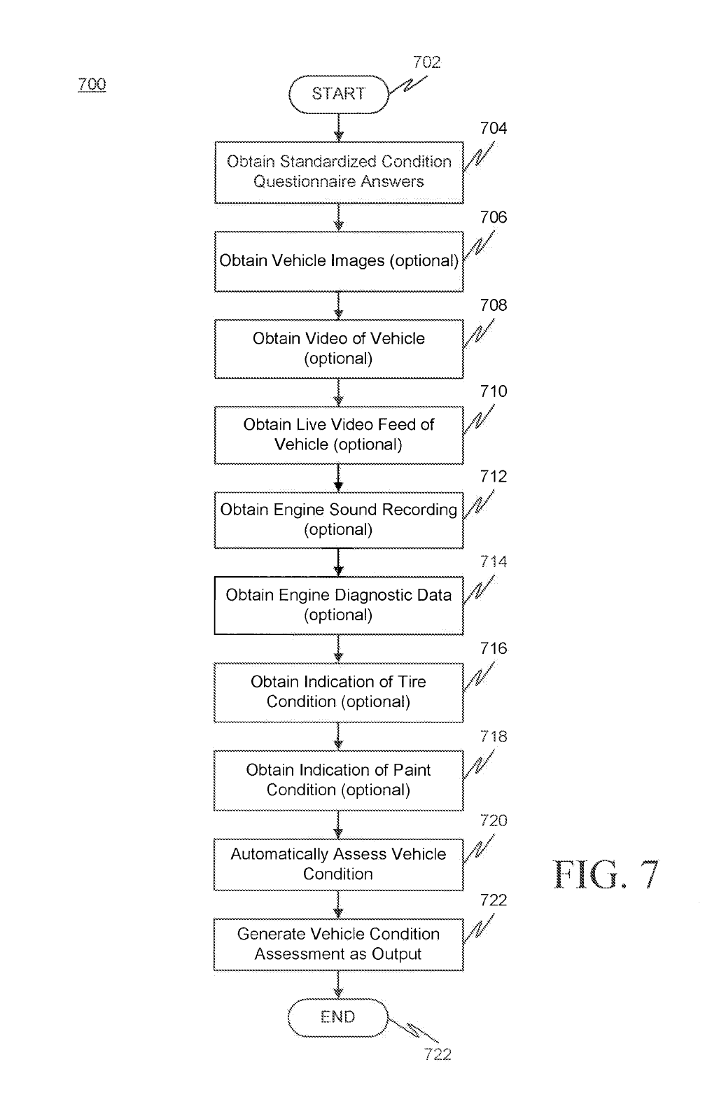

FIG. 7 is a chart of a method 700 for automatically assessing vehicle condition. Processing begins at 702 and continues to 704.

At 704, answers to standardized vehicle condition questions are obtained. Processing continues to 706, 706-718 are each optional.

At 706, one or more digital still images of the vehicle are obtained. Processing continues to 708. At 708, one or more digital videos of the vehicle are obtained. Processing continues to 710.

At 710, a live video feed of the vehicle is obtained. The live video feed can be obtained and provided by the seller device to a server computer and in turn to prospective buyer devices. The video feed can be obtained and stored for later playback or can be provided in real-time. Processing continues to 712.

At 712, a sound recording of the vehicle engine can be obtained. The engine sound recording can be analyzed (e.g., compared to a reference recording or signal processed) to determine if there are possible engine problems. Processing continues to 714.

At 714, engine diagnostic data is obtained. The engine diagnostic data can be obtained from the vehicle diagnostic computer or from an online source of vehicle diagnostic data that has been retrieved from the vehicle via a wired or wireless connection and recorded. Processing continues to 716.

At 716, an indication of tire condition is obtained. The indication of tire condition can include tread depth. The indication can be manually entered or automatically captured. Processing continues to 718.

At 718, an indication of paint condition is obtained. The indication of paint condition can be manually entered or automatically obtained (e.g., from a paint thickness meter). Processing continues to 720.

At 720, the condition of the vehicle is automatically assessed based on the information obtained at 704-718. Processing continues to 722.

At 722, a vehicle condition assessment report is provided as output. The report can be displayed, printed or electronically transmitted. Processing continues to 724, where processing ends.

It will be appreciated that 702-722 can be repeated in whole or in part in order to accomplish a contemplated vehicle condition assessment process.

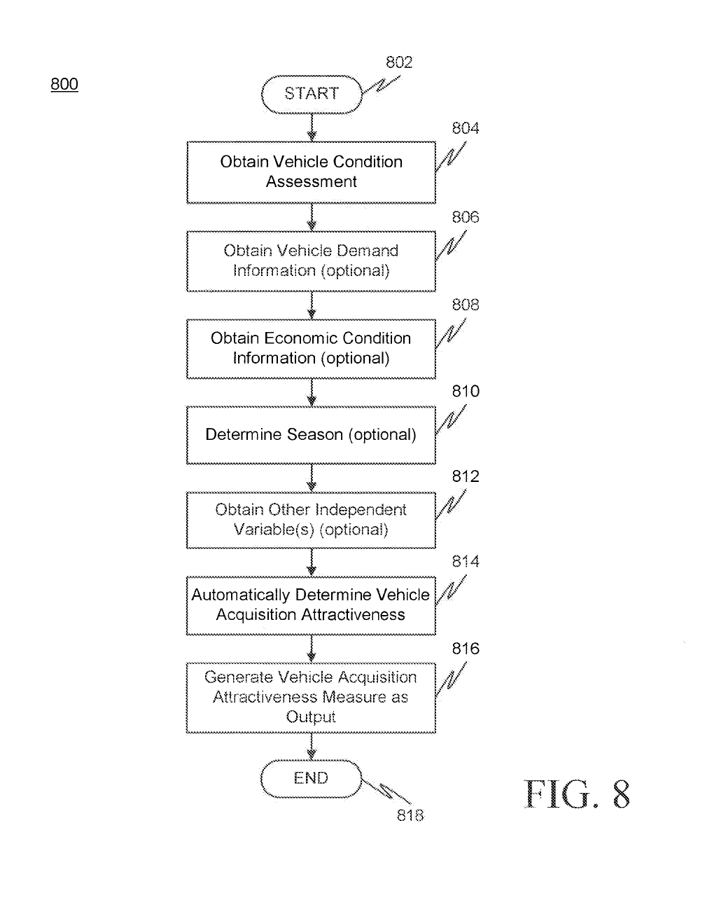

FIG. 8 is a chart of a method 800 for automatically generating a measure of vehicle acquisition attractiveness. Processing begins at 802 and continues to 804.

At 804, the vehicle condition assessment is obtained. The vehicle assessment can include the assessment report generated at 722 of FIG. 7. The vehicle condition assessment can also include one or more of the information items obtained at 704-718. Processing continues to 806, with 806-812 being optional.

At 806, vehicle demand information (e.g., as described in connection with 606 of FIG. 6) is obtained. Processing continues to 808.

At 808, economic condition information (e.g., as described in connection with 602 of FIG. 6) is obtained. Processing continues to 810. At 810, the season is determined. Processing continues to 812. At 812, other independent variables (e.g., as described in connection with 608 of FIG. 6) are determined or obtained. Processing continues to 814.

At 814, vehicle acquisition attractiveness is automatically determined. Vehicle acquisition attractiveness can include a measure of the attractiveness of a particular vehicle for acquisition by a particular buyer. In addition: to an acquisition attractiveness measure, a bid price can automatically be determined and provided to a bidder. The acquisition attractiveness determination and bid price determination can be based in-part on parameters established by a buyer, such as desired price range, acceptable profitability, upper mileage limit, etc. Processing continues to 816.

At 816, the vehicle acquisition attractiveness measure is provided as output. Processing continues to 81.8, where processing ends.

While embodiments have been described in relation to an individual seller to one or more dealer bidders, it will be appreciated that an embodiment can work equally well among sellers and buyers that are individuals or dealers.

The vehicle condition assessment and vehicle acquisition attractiveness methods and system could be used by a buyer at a “live” venue such as an auto auction. In such an embodiment, the buyer may be both entering data about the vehicle and may be reviewing the assessments to make a buying decision. Accordingly, the seller device and the buyer device in this case may be the same device.

A vehicle, as used herein, refers to an automobile, a truck, a motorcycle or any type of apparatus capable of transporting cargo or people. While embodiments have been described in terms of vehicle auctions or sales, it will be appreciated that embodiments could he adapted for selling other types of goods or services. For example, an embodiment can be applied to online auction sales of art, antiques, books, boats, aircraft, jewelry, livestock, animals, machinery, real estate or other items. In general, any item for service) which can be sold through an online auction process and for which visual inspection may be desired, geographic location of buyer and seller may be a factor, and large numbers of transactions make a predictive or preference-based push technique desirable could be sold through an embodiment of the present invention adapted for the particular type of good or service being contemplated.

It will be appreciated that the modules, processes, systems, and sections described above can be implemented in hardware, hardware programmed by software, software instructions stored on a nontransitory computer readable medium or a combination of the above. A system for conducting a vehicle auction, automatically assessing vehicle condition and automatically assessing vehicle acquisition attractiveness can be implemented, for example, using a processor configured to execute a sequence of programmed instructions stored on a nontransitory computer readable medium. For example, the processor can include, but not be limited to, a personal computer or workstation or other such computing system that includes a processor, microprocessor, microcontroller device, or is comprised of control logic including integrated circuits such as, for example, an Application Specific integrated Circuit (ASIC). The instructions can be compiled from source code instructions provided in accordance with a programming language such as Java, C++, C#.net or the like. The instructions can also comprise code and data objects provided in accordance with, for example, the Visual Basic™ language, or another structured or object-oriented programming language. The sequence of programmed instructions and data associated therewith can be stored in a nontransitory computer-readable medium such as a computer memory or storage device which may be any suitable memory apparatus, such as, but not limited to ROM, PROM, EEPROM, RAM, flash memory, disk drive and the like.

Furthermore, the modules, processes systems, and sections can be implemented as a single processor or as a distributed processor. Further, it should be appreciated that the steps mentioned above may be performed on a single or distributed processor (single and/or multi-core). Also, the processes, system components, modules, and sub-modules described in the various figures of and for embodiments above may be distributed across multiple computers or systems or may be co-located in a single processor or system. Exemplary structural embodiment alternatives suitable for implementing the modules, sections, systems, means, or processes described herein are provided below.

The modules, processors or systems described above can be implemented as a programmed general purpose computer, an electronic device programmed with microcode, a hard-wired analog logic circuit, software stored on a computer-readable medium or signal, an optical computing device, a networked system of electronic and/or optical devices, a special purpose computing device, an integrated circuit device, a semiconductor chip, and a software module or object stored on a computer-readable medium or signal, for example.

Embodiments of the method and system (or their sub-components or modules), may be implemented on a general-purpose computer, a special-purpose computer, a programmed microprocessor or microcontroller and peripheral integrated circuit element, an ASIC or other integrated circuit, a digital signal processor, a hardwired electronic or logic circuit such as a discrete element circuit, a programmed logic circuit such as a PLD, PLA, FPGA, PAL, or the like. In general, any processor capable of implementing the functions or steps described herein can be used to implement embodiments of the method, system, or a computer program product (software program stored on a nontransitory computer readable medium).

Furthermore, embodiments of the disclosed method, system, and computer program product may be readily implemented, fully or partially, in software using, for example, object or object-oriented software development environments that provide portable source code that can he used on a variety of computer platforms. Alternatively, embodiments of the disclosed method, system, and computer program product can be implemented partially or fully in hardware using, for example, standard logic circuits or a VLSI design. Other hardware or software can be used to implement embodiments depending on the speed and/or efficiency requirements of the systems, the particular function, and/or particular software or hardware system, microprocessor, or microcomputer being utilized. Embodiments of the method, system, and computer program product can be implemented in hardware and/or software using any known or later developed systems or structures, devices and/or software by those of ordinary skill in the applicable art from the function description provided herein and with a general basic knowledge of the user interface and/or computer programming arts.

Moreover, embodiments of the disclosed method, system, and computer program product can be implemented in software executed on a programmed general purpose computer, a special purpose computer, a microprocessor, or the like.

It is, therefore, apparent that there is provided, in accordance with the various embodiments disclosed herein, computer systems, methods and software for conducting a vehicle auction, automatically assessing vehicle condition and automatically assessing vehicle acquisition attractiveness.

While the invention has been described in conjunction with a number of embodiments, it is evident that many alternatives, modifications and variations would be or are apparent to those of ordinary skill in the applicable arts. Accordingly, Applicant intends to embrace all such alternatives, modifications, equivalents and variations that are within the spirit and scope of the invention.

What is claimed is:

1. A computerized method for offering a vehicle for sale, the method comprising:
obtaining, at a processor, vehicle identification information for the vehicle;
transmitting the vehicle identification information to an external server via a communications network;
receiving, at the processor, a set of questions specific to a make, model and year of the vehicle;
displaying each question on a display device coupled to the processor;
receiving, at the processor, an answer to each question and vehicle condition information in a predetermined format;
obtaining at least one image of the vehicle;
obtaining a location of the seller device or the vehicle;
transmitting the location, the vehicle condition information, the answers and the at least one image to the external server;
receiving one or more offers transmitted from the external server, the offers being ranked by rating value of a buyer associated with each offer;
displaying the offers on the display device;
receiving, at the processor, an indication of a selected offer; and
transmitting the indication of the selected offer to the external server.

2. The method of claim 1, wherein the vehicle identification information includes vehicle identification number (VIN) and/or vehicle make and model.

3. The method of claim 1, wherein the vehicle identification information is obtained directly from the vehicle or from a database coupled to the processor.

4. The method of claim 1, wherein the vehicle condition information includes vehicle mileage.

5. The method of claim 1, further including obtaining additional condition information including one or more of paint condition, tire condition and engine condition.

6. The method of claim 5, wherein the paint condition is obtained using a paint thickness meter the engine condition is obtained by reading engine diagnostic codes through an interface coupled to the processor or by sampling an engine sound using a microphone coupled to processor and analyzing the engine sound, and the tire condition is determined by obtaining an image of one or more tires of the vehicle.

7. The method of claim 1, further including presenting optional services ion the display device, the optional services including one or more of insurance, warranty, certified inspection, escrow service and third party vehicle exchange.

8. A nontransitory computer readable medium having program instructions stored thereon that, when executed by a processor, cause the processor to perform operations comprising:
obtaining, at the processor, vehicle identification information for the vehicle,
transmitting the vehicle identification information to an external server via a communications network;
receiving, at the processor, a set of questions specific to a make, model and year of the vehicle;
displaying each question on a display device coupled to the processor;
receiving, at the processor, an answer to each question and vehicle condition information in a predetermined format;
obtaining at least one image of the vehicle;
obtaining a location of the seller device or the vehicle;
transmitting the location, the vehicle condition information, the answers and the at least one image to the external server;
facilitating anonymous communication between sellers and buyers by transmitting an offer to sell the vehicle and receiving one or more offers to buy the vehicle transmitted from the external server, the offers being ranked by rating value of a buyer associated with each offer;
displaying the offers on the display device;
receiving, at the processor, an indication of a selected offer; and
transmitting the indication of the selected offer to the external server and supplying seller contact information to a buyer corresponding to the selected offer and supplying buyer contact information to the seller.

9. The nontransitory computer readable medium of claim 8, wherein the vehicle identification information includes vehicle identification number and/or vehicle make and model.

10. The nontransitory computer readable medium of claim 8, wherein the vehicle identification information is obtained directly from the vehicle or from a database coupled to the processor.

11. The nontransitory computer readable medium of claim 8, wherein the vehicle condition information includes vehicle mileage.

12. The nontransitory computer readable medium of claim 8, wherein the operations further include obtaining additional condition information including one or more of paint condition, tire condition and engine condition.

13. The nontransitory computer readable medium of claim 12, wherein the paint condition is obtained using a paint thickness meter, the engine condition is obtained by reading engine diagnostic codes through an interface coupled to the processor or by sampling an engine sound using a microphone coupled to processor and analyzing the engine sound, and the tire condition is determined by obtaining an image of one or more tires of the vehicle.

14. The nontransitory computer readable medium of claim 8, wherein the operations further include presenting optional services on the display device, the optional services including one or more of insurance, warranty, certified inspection, escrow service and third party vehicle exchange.

15. A computerized method for operating a server to conduct a vehicle sale, the method comprising:
receiving, at the server, a request for a new vehicle listing, the request including vehicle identification information;
using the vehicle identification information to look up the vehicle in a database and to obtain one or more questions based on the vehicle make, model and year;
transmitting the questions to an external seller device;
receiving location, condition, mileage and images from the external seller device;
creating a new vehicle sale listing and storing the listing in a vehicle sale listing database table;
filtering a list of buyers based on predicted interest and pushing the new vehicle sale listing to buyers having a predicted interest;
receiving, offers from one or more buyers;
storing offers in the database; and
transmitting the offers to the external seller device.

16. The method of claim 15, wherein the predicted interest is based on one or more of location, buying patterns, sales patterns, VIN scanning patterns, wish lists and local market factors.

17. The method of claim 15, wherein the vehicle identification information includes vehicle identification number and/or vehicle make and model.

18. The method of claim 15, wherein the vehicle identification information is obtained directly from the vehicle or from a database coupled to the processor.

19. The method of claim 15, further including obtaining additional condition information including one or more of paint condition, tire condition and engine condition.

20. The method of claim 19, wherein the paint condition is obtained using a paint thickness meter, the engine condition is obtained by reading engine diagnostic codes through an interface coupled to the processor or by sampling an engine sound using a microphone coupled to processor and analyzing the engine sound, and the tire condition is determined by obtaining an image of one or more tires of the vehicle.
